(19) United States
(12) Patent Application Publication
(10) Pub. No.: US 2018/0290068 A1
(43) Pub. Date: Oct. 11, 2018

(54) MANIPULABLE BLOCKS THAT TRANSMIT COMMANDS TO OBJECTS OR ANIMATIONS BASED ON THE POSITIONING OF THE MANIPULABLE BLOCKS

(71) Applicant: Codie, LLC, Nyack, NY (US)

(72) Inventor: Don Moody, Nyack, NY (US)

(21) Appl. No.: 15/947,186

(22) Filed: Apr. 6, 2018

Related U.S. Application Data
(60) Provisional application No. 62/483,023, filed on Apr. 7, 2017.

(51) Int. Cl. A63H 30/04; A63H 33/04; G06K 19/07; G06K 7/10

(52) U.S. Cl. CPC A63H 30/04; A63H 33/042; A63H 2200/00; G06K 7/10475; G06K 19/0723

(57) ABSTRACT

Described is a system for controlling an object via multiple multi-sided manipulable objects. The system includes multiple manipulable objects having distinct sides. Each manipulable object includes one or more radio frequency identification (RFID) chips. The system also includes a recipient object and a platform for receiving manipulable objects. The platform comprises a RFID reader which can detect, using the at least one RFID chip in each manipulable object, a position, an orientation, and an order of one or more manipulable objects placed on the platform. The platform is configured for emitting a command to the recipient object corresponding to the position, the orientation, and the order of the one or more manipulable objects placed on the platform.

### CROSS-REFERENCE TO RELATED APPLICATIONS

This is a Non-Provisional Patent Application of U.S. Provisional Patent Application No. 62/483,023, filed in the United States on Apr. 7, 2017, entitled, “Manipulable Blocks that Transmit Commands to Objects or Animations Based on the Positioning of the Manipulable Blocks,” the entirety of which is incorporated herein by reference.

### BACKGROUND OF THE INVENTION

### (1) Field of Invention

The present invention relates to manipulable objects and, more particularly, to a collection of manipulable objects that transmit commands to objects or for the generation of animations based on the positioning, orientation, or sequence of the manipulable objects.

### (2) Description of Related Art

Toy objects, such as vehicles (e.g., cars) and figures (e.g., robots), are often controlled using a remote control device. Such a remote control device typically includes a variety of commands that are actuated, for example, via buttons or other inputs. While operable for controlling the relevant toy object, such remote control devices do not allow for providing commands based on the actual physical position, placement, or orientation of the remote control device.

In other art are computer generated animations that feature a variety of characters or objects that can perform a variety of commandable actions. For example, in a video game setting, an operator can use an input device to cause the character to jump, or walk forward, etc. While operable for inputting the commands, such input devices do not allow for providing commands based on the actual physical position or placement of the input device.

Thus, a continuing need exists for a system that incorporates a collection of manipulable objects that transmit commands to objects or for the generation of animations based on the positioning, orientation, or sequence of the manipulable objects.

### SUMMARY OF THE INVENTION

The present invention relates to manipulable objects and, more particularly, to a collection of manipulable objects that transmit commands to objects or for the generation of animations based on the positioning, orientation, or sequence of the manipulable objects. The present invention comprises a system including a plurality of manipulable objects having distinct sides, wherein each manipulable object comprises at least one radio frequency identification (RFID) chip; a recipient object; and a platform for receiving at least one manipulable object. The platform comprises a RFID reader which can detect, using the at least one RFID chip in each manipulable object, at least one of a position, an orientation, and an order of one or more manipulable objects placed on the platform. The platform is configured for emitting a command to the recipient object corresponding to at least one of the position, the orientation, and the order of the one or more manipulable objects placed on the platform.

In another aspect, each manipulable object is a block, and each distinct side of the block comprises an image conveying a command related to an object, animal, person, action, alphanumeric character, symbol, or emotion.

In another aspect, the recipient object is a toy object capable of movement, and the platform is configured for wirelessly transmitting a command or sequence of commands to the toy object corresponding to an image on a block or a sequence of images on a sequence of blocks positioned on the platform to induce movement of the toy object.

In another aspect, the toy object is a toy car.

In another aspect, the toy object is a toy robot.

In another aspect, the recipient object is an electronic device having a display screen, and the platform is configured for wirelessly transmitting a command or sequence of commands to software on the electronic device capable of rendering graphics on the display screen corresponding to an image on a block or a sequence of images on a sequence of blocks positioned on the platform.

In another aspect, the system comprises an additional platform having a connection mechanism for connecting with one or more other platforms.

In another aspect, the platform comprises a plurality of rows for receiving the plurality of manipulable objects.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for transmitting commands to objects or animations according to some embodiments of the present disclosure;

FIG. 2 is an illustration of a computer program product according to some embodiments of the present disclosure;

FIG. 3 is an illustration of a block and tray set for transmitting commands to objects or animations according to embodiments of the present disclosure;

FIG. 4A is an illustration of blocks according to embodiments of the present disclosure;

FIG. 4B is an illustration of trays according to embodiments of the present disclosure;

FIG. 5 is an illustration of trays and tracks according to embodiments of the present disclosure;

FIG. 6 is an illustration of icons for blocks according to embodiments of the present disclosure;

FIG. 7A is an illustration of a single row tray with blocks according to embodiments of the present disclosure;

FIG. 7B is an illustration of a multi-row tray with blocks according to embodiments of the present disclosure;

FIG. 8 is an illustration of a child using the tray and block set according to embodiments of the present disclosure;

FIG. 9A is an illustration of a female character walking on a mobile device display according to embodiments of the present disclosure;

FIG. 9B is an illustration of the female character in FIG. 9A spinning after placement of a block representing a spin command is placed in the tray according to embodiments of the present disclosure;

FIG. 10A is an illustration of a toy car, blocks, and tray according to embodiments of the present disclosure;

FIG. 10B is an illustration of placement of a block representing a move right command in the tray to cause the toy car to move right according to embodiments of the present disclosure;

FIG. 10C is an illustration of placement of another move right block in the tray to cause the toy car to move further right according to embodiments of the present disclosure;

FIG. 11A is an illustration of a toy robot, blocks, and tray according to embodiments of the present disclosure;

FIG. 11B is an illustration of placement of a block representing facing upward in the tray to cause the toy robot to face upward according to embodiments of the present disclosure;

FIG. 11C is an illustration of placement of a block representing a smile in the tray to cause the toy robot to laugh according to embodiments of the present disclosure; and

FIG. 12 is an illustration of an example interface according to embodiments of the present disclosure.

### DETAILED DESCRIPTION

The present invention relates to manipulable objects and, more particularly, to a collection of manipulable objects that transmit commands to objects or for the generation of animations based on the positioning, orientation, or sequence of the manipulable objects. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Principal Aspects

Various embodiments of the invention include several “principal” aspects. One principal aspect is a collection of manipulable objects (e.g., blocks, cubes, 8-sided item, etc., or other items with distinct sides) and receiving tracks that transmit commands to toy objects or for the generation of animations based on the positioning, orientation, or sequence (ordering) of the manipulable objects. Other examples of such manipulable objects include, triangle blocks, octagonal blocks, 30-shape sided blocks, odd-shaped blocks that aren't symmetrical, etc. Further, “codie blocks” are a collection of manipulable objects (e.g., blocks) that can be positioned within a track or other item. Based on the orientation of the blocks and position of the blocks in relation to the other blocks, a series of commands are generated. For example, the blocks have radio-frequency identification (RFID) chips that can transmit the particular block that is positioned on a track. Given the collection of blocks, the track (with RFID readers (or other suitable technology)), is then aware of the particular ordering of the blocks. For instance, when placed in a specific order, the track or tray reads a sequence of commands. Specific sequences can result in specific commands. Furthermore, a sequence of commands can be saved and then played at a later time. Additionally, a sequence of commands can be stored into a macro command.

As far as orientation, there are a number of techniques that can be employed to cause the track to detect the particular orientation of any given block, non-limiting example of which include bumps, RFID shielding, orientation sensors within each block, etc. Thus, when the blocks or manipulable objects are placed in the track, the track is able to sense the orientation and ordering of the manipulable objects. Given the orientation and order, the track emits a corresponding ordered command (via any suitable transmission technique) to the recipient object. For example, if the recipient object is a toy car, the commands may be “go forward”, “go forward”, “turn left”, “go forward”, which the toy car then performs.

In another aspect, the recipient object could be a tablet computer (e.g., iPad, phone, etc.) or other item with a display that is capable of receiving the communication and rendering an animation that corresponds to the command. For example, the blocks may be positioned such that the first block (image up) is a robot, and following blocks include the commands (via, for example, the image on the top surface) “run”, “turn”, and “smile.” Then, with the appropriate app or software program loaded into the recipient object (e.g., iPad), the recipient object then renders the applicable animation. In this example, a robot would be displayed that runs, turns, and then smiles. As can be appreciated by those skilled in the art, there are any number of various commands that can be generated given the specific ordering and orientation of the manipulable objects.

Another principal aspect is a system that is typically in the form of a computer system operating software or in the form of a “hard-coded” instruction set. This system may be incorporated into a wide variety of devices that provide different functionalities. The system is, for example, the relevant computing system that is operable for performing the operations, including receiving the commands and generating the relevant ordered display.

Yet another principal aspect is a method, typically in the form of software, operated using a data processing system (computer). The fourth principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

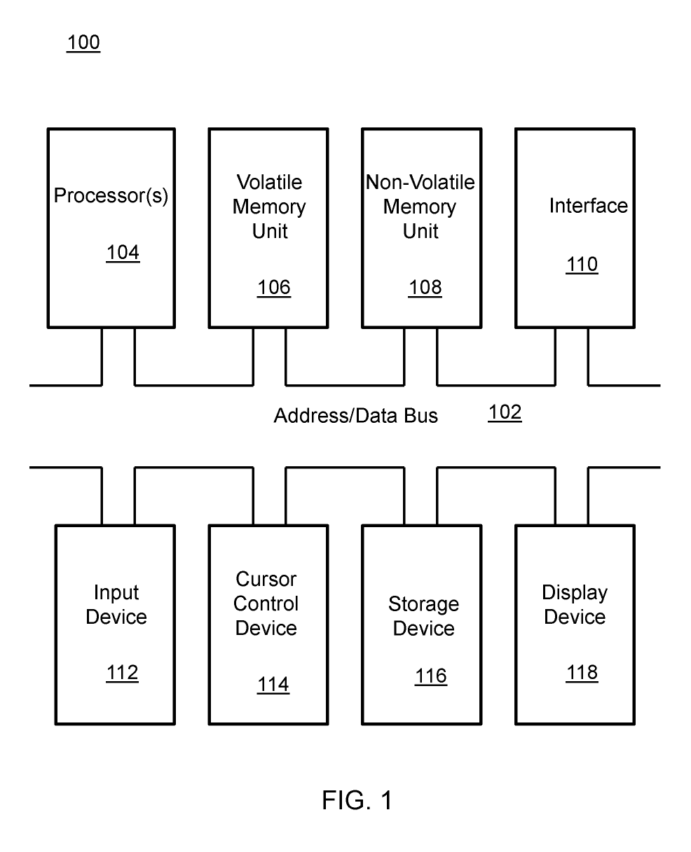

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include an address/data bus 102 that is configured to communicate information. Additionally, one or more data processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM

(“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice commands.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive (“HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

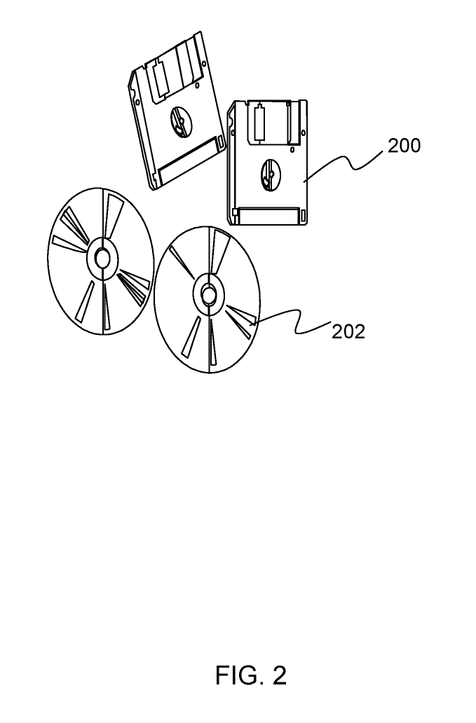

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium, such as a hard drive, integrated circuit, etc. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(2) Specific Details of the Invention

As noted above, the present invention is directed to a collection of manipulable objects. The manipulable objects are any suitable object that includes a plurality of distinct sides. As a non-limiting example, the manipulable objects are blocks, such as the “codie blocks” as described above. The blocks have several distinct sides, each with a depiction or meaning that is intended to convey a particular item, action, emotion, symbol, etc. The blocks are recognizable, concrete, tangible, three-dimensional (3D) objects users, in particular young children, are familiar with and can relate to. In the present invention, some blocks represent an object that can easily translate from a tactile real world off-screen to a visual two-dimensional (2D) world onscreen, such as on a tablet, mobile phone, or other electronic device having a display screen. Furthermore, the blocks allow children to use to the tools most familiar to them, their hands, to explore, manipulate, experiment, play, and create to solve a problem. Significantly, the present invention functions in teaching children symbolization, sequencing, debugging, and computational thinking.

The blocks can be placed in a track, tray, or any other suitable item that is capable of receiving the blocks. In some aspects, the track can sense the ordering and orientation of the blocks to determine the item, action, symbol and/or emotion that is being depicted on the face (e.g., top face) of the blocks. Based on the determined item, action, and/or emotion, etc. the relevant command sequence is transmitted (e.g., wirelessly, radio frequency identification (RFID), Bluetooth, etc.) by the track to a recipient object, such as either a real-world toy object (e.g., toy car, toy train, toy robot, etc.) to perform the command sequence or to a graphic display device (e.g., iPad, etc.) that is capable of receiving the transmission and rendering a graphic or display that is coordinated with the command sequence. The starter tray (or block dock) is constructed with a ‘run the code’ block and room for additional blocks. Extension trays or docks can be connected to the starter tray, adding room for additional blocks. In one embodiment, each block is a 1.25 inch cube, a size large enough to prevent choking in young children.

Using RFID technology within the blocks and tray, a child can control characters on an electronic device display screen (e.g., iPad screen) by manipulating the blocks. RFID uses electromagnetic fields to automatically identify and track tags attached to objects. The tags contain electronically-stored information. Passive tags collect energy from a nearby RFID reader's radio waves. Active tags have a local power source (such as a battery). Bluetooth technology can also be used for communication between the blocks and tray. Bluetooth is a wireless technology for exchanging data over short distances from fixed and mobile devices. A master Bluetooth device can communicate with multiple devices in an ad-hoc computer network using Bluetooth technology.

Data can be transferred between the master device and one other slave device. In one embodiment, the tray (platform) is the master device, while extension trays or tracks are the slave devices. There can be more than one slave device; in fact, there can be many slave devices.

The block tray is used as an anchor, making it simple and obvious for young children to understand where the blocks go. Users begin by playing with the blocks to see what happens when each command (provided by each block) is placed in the tray. Extension trays/docks allow for endless play and coding. If a child puts any block in the tray, it will trigger an on-screen action on the electronic device. Providing an immediate response is critical to helping children understand that the command icon has meaning and that they are the ones choosing the command and making the game happen. When there are multiple blocks in the tray, the child may press the ‘run the code’ block and the entire sequence will execute, left to right and top to bottom. The blocks use standard commands common to other programs. Moreover, the present invention uses commands and fun themes that better connect with younger children, such as emotions, symbols, colors, weather, dancing, music, and more.

It should also be noted that in other aspects the manipulable objects themselves include all of the necessary hardware to collectively determine the orientation and positioning of the blocks and transmit the relevant command sequence to the recipient object. Thus, in such a configuration, the blocks or manipulable objects can be used to control the recipient object directly without the need for the track or other item upon which the manipulable objects are placed.

Finally, it should be noted that the present invention also includes the software and other hardware components that may be required to perform the relevant operations as described herein and the accompanying documents. As a non-limiting example, a cable can be used to connect the tray with the touch screen device (or they can communicate wirelessly), a cable or wireless technologies can be also used to link a master black into the track or touchscreen, etc. The relevant components also include all of the circuitry, sensors, etc. as may be required to perform the relevant operations.

For example, the tray and tracks can include custom printed circuit boards (PCBs) with multiple (e.g., 7) antennas. A near field communication (NFC) reader chip in the tray/tracks can be utilized to read multiple antennas. A Bluetooth low energy (BLE) module can be used for communication with a mobile device (e.g., tablet, phone). Custom firmware can read blocks and share the identification (ID) data to the mobile device. The tray can be constructed with lights to guide kids through the play and learning process. The blocks can be constructed with near field communication (NFC) enabled chips. The game app can be built with the unity engine, and the three-dimensional (3D) animation can be run on a mobile operating system, such as iOS. Further details are provided below. Note that the specific examples as provided below are for illustrative purposes of suitable embodiments or aspects and that the invention is not intended to be limited thereto.

(2.1) Codie Block Set

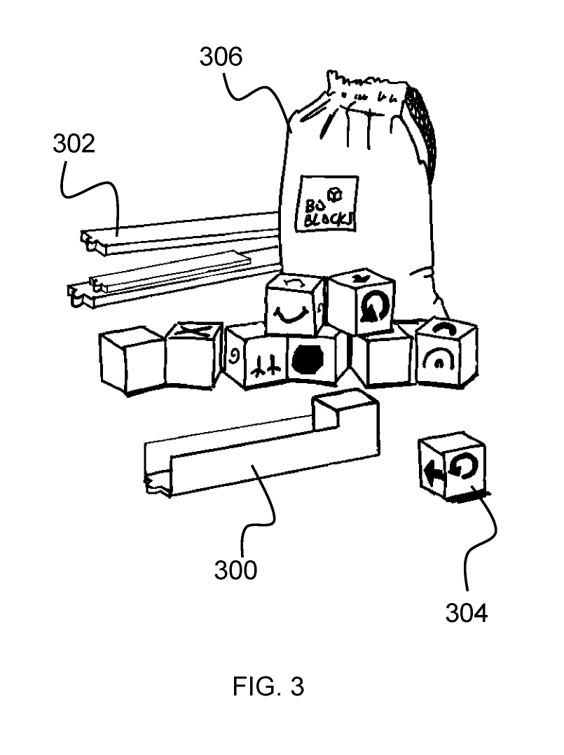

As depicted in FIG. 3, the Codie Block Set consists of several types of objects/toys, including beginner trays 300, tracks 302, blocks 304, and object toys (i.e., recipient object). A storage bag 306, or any other suitable storage device (e.g., box with lid), can be included and used to contain the elements of the set.

(2.1.1) Trays 300

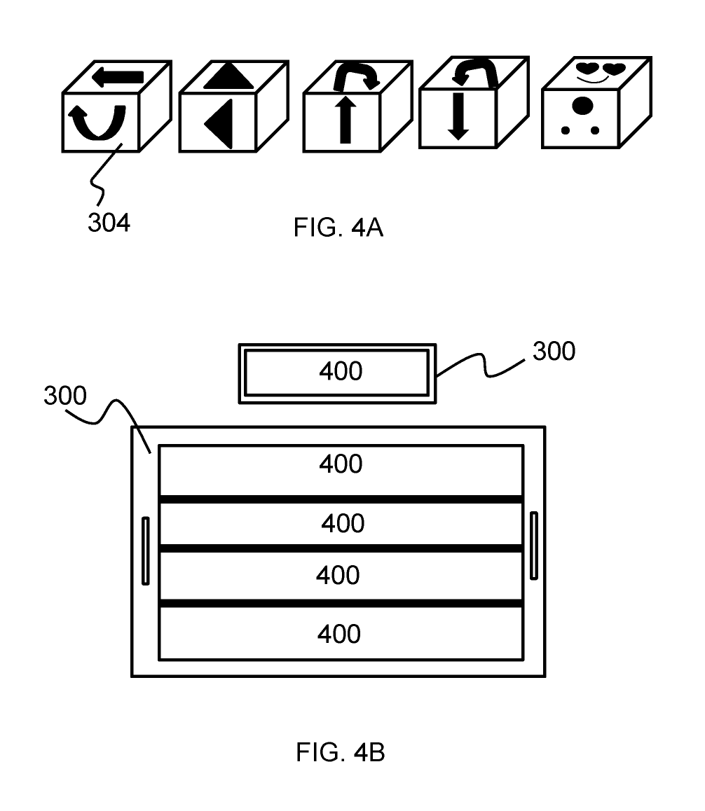

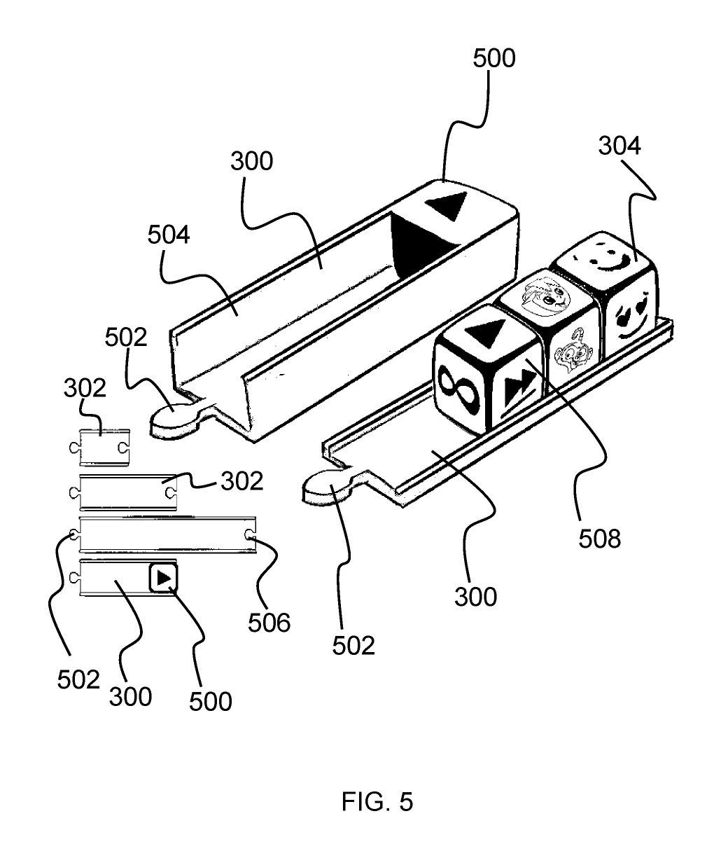

There are several different styles of trays 300. The variations include tray size (i.e., the number of free-standing blocks the tray holds), types of blocks on the ends, types of walls on all sides, and type of connector the tray 300 has at the end. The tray 300 can come in many different sizes. The smallest size is small enough for one block, and the largest size is large enough for up to thirty-six blocks to be held inside it. Trays 300 can consist of one or more rows 400, as shown in FIG. 4, with each row 400 holding between one and six blocks. As can be appreciated by one skilled in the art, any other configuration having any number of rows 400 for any number of blocks, including a massive wall for a group project, is possible. As illustrated in FIG. 5, some trays 300 can work by themselves (as indicated by the command element 500), while other trays are tracks 302 that need to connect via a connection mechanism 502 with one another on the left, right, top, or bottom with other trays 300, making a complete network of trays and tracks.

A beginner tray 300 (referring to a beginner user) can have a number of different combinations of blocks 304 throughout or on the ends that can be used to generate the command. As non-limiting examples, the beginner tray 300 may have these different combinations of blocks 304 on the ends:
1) Play Block on left, and Stop block on right;
2) Object Block on left, and Stop block on right;
3) Object Block on left, and Play Block on Right;
4) Play block on left only;
5) Play Block on right only;
6) Object Block on Left only; and
7) Object block on right only.

Referring to FIG. 5, the walls 504 of the tray may have different height levels on different trays. For instance, there can be no wall on any of the sides of a tray (such as the embodiment shown to the right in FIG. 5) other than the blocks 304. Alternatively, there can be very short walls 504, enough to keep the blocks 304 in place. In addition, there can be walls 504 the same height of the blocks 304 so they fit entirely into the tray 300. Furthermore, some of the walls 504 can have gentle curves, and others will be at complete right angles.

Regarding connections, the tray 300 can have a ‘male’ connector (element 502) at the end protruding out of any side. In addition, the tray 300 can have a ‘female’ connector (element 506) on the end, with an inward opening on any side. Also, the tray 300 can have a flat end on any side. If it has a flat end, the connectors can be magnets or a snap-fit mechanism for connection to tracks or other types of connectors to hold it in place. Finally, the tray 300 can have any combination of the above on all sides.

(2.1.2) Tracks 302

The tracks 302 are extensions of the tray 300 that may or may not have any walls. The tracks 303 can have a ‘male’ connector (element 502) at the end protruding out, and a female connector (element 506) on the opposite end, with an inward opening. Alternatively, the tracks 302 can have flat ends on both sides. The tracks 302 come in many sizes. As a non-limiting example, the tracks 302 are between one and six blocks in length and between one and six blocks in height. In addition, the tracks 302 can be bendable and/or have sticky tape (or any other suitable attachment mechanism) on the underside so they can adhere to walls, ceilings, or any object, such as a car. For the purposes of this disclosure, trays 300 and tracks 302 can also be referred to as a platform.

(2.1.3) Blocks 304

In the invention described herein, there are several types of blocks 304, as designated by the shape, markings, or artwork on the block 304. Examples of such items that may be used to designate the type of block 304 include letters, words, English and other languages, including Braille and beyond, math, numbers, images or markings indicative of geometry, science, geography, and history, etc. Examples of block 304 types include, but are not limited to control blocks, character blocks, object blocks, motion blocks, action blocks, emotion blocks, looks blocks, color blocks, and sound blocks. As described above, the blocks elicit commands based on the communication between the blocks and the tray/track. Thus, references to control blocks, character blocks, object blocks, motion blocks, action blocks, emotion blocks, looks blocks, color blocks, and sound blocks are equivalent to control commands, character commands, object commands, motion commands, action commands, emotion commands, looks commands, color commands, and sound commands.

Similar to the control element 500 that is part of the tray 300 shown in FIG. 5, control blocks (element 508 in FIG. 5) indicate command functions, such as play, stop, repeat (twice, repeat 3x, repeat 4x, 5x, etc.), play twice as fast, play at half speed, repeat infinitely, and play backwards. Character blocks 304 come in assorted types. For instance, the character blocks 304 can include images of characters on them from a television or Internet show (e.g., Mia & Codie) or movie. Further, the images may be obtained from other intellectual properties via licensing (e.g., Bugs Bunny, Batman). Additionally, the image on the character block 304 may be a person or persons, such as a celebrity, athlete, or a family member's image custom engraved on the block. A character block 304 can have one character and several specific actions relating to that character. As another example, an entire block 304 might have art related to one character or command, and that block 304, no matter what its orientation when placed in the tray, provides the same command.

Object blocks 304 include the characters or images described above in addition to including various objects, such as a toy car, a stuffed animal, a toy fire truck, school bus, helicopter, robot, backpack, carrying case, Tupperware, beach ball, rocket, or airplane. Motion blocks 304 typically provide a command for an object to move. Non-limiting examples of movements include directional movements, such as right, left, up, and down, and specific actions, such as jump, spin, bend, sit, and fly.

Action blocks 304 include items such as dance, laugh, tickle, swipe, punch, block, kick, bend, sit, throw, flip, pee, poop, fart, burp, and explode. Non-limiting examples of emotion blocks include “make happy”, “make sad”, “make angry”, “make surprised”, “show love”, “act in love”, “laugh”, and “act embarrassed”. Color blocks 304 include colors to make an object light up a certain color or a digital image turn a certain color. Looks blocks 304 control image effects. For instance, they can make an image bigger, smaller, disappear, or double.

Additionally, images can be added to an existing image, such as chicken feet, a wig, clown nose, angel's wings, and any other desired image or effect.

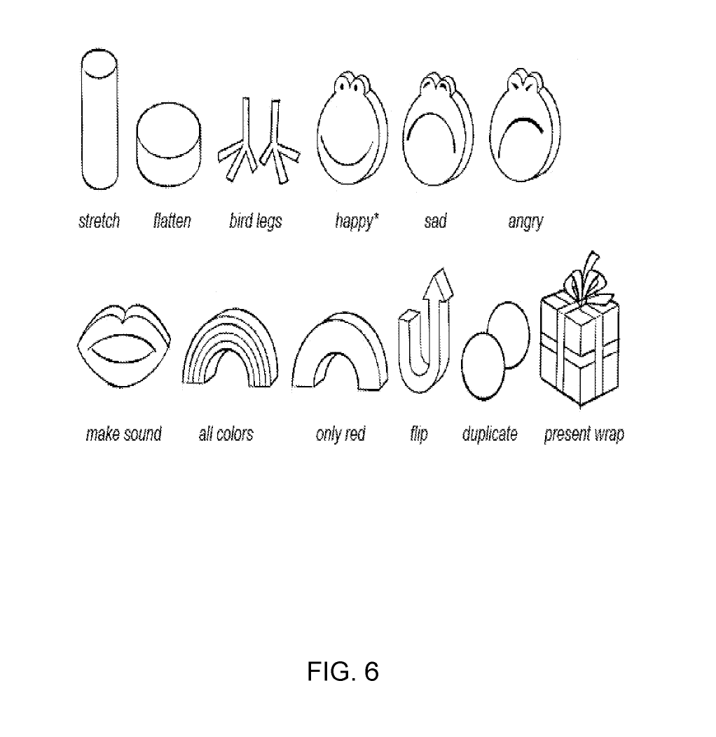

Sound blocks 304 function in multiple ways. They can produce the sounds representing images/characters of the block or blocks 304 before a given block 304 in the tray 300. Moreover, sound blocks 304 can create their own sound (e.g., cow moo, sheep hay, explosion, bell) or can load a custom sound to a block 304, such as a recording of a person's voice. Examples of sounds that can be used in conjunction with the blocks 304 include, but are not limited to, vehicle sounds, animal sounds, sports sounds, music, swimming sounds, different types of laughter, screams, and whelps. FIG. 6 depicts examples of images that can be displayed on blocks 304. Shown are stretch, flatten, bird legs, happy, sad, angry, make sound, all colors, only red, flip, duplicate, and present wrap. Notably, the artwork or commands on the blocks 304 impact the real world object's actions or the animations on the digital screen.

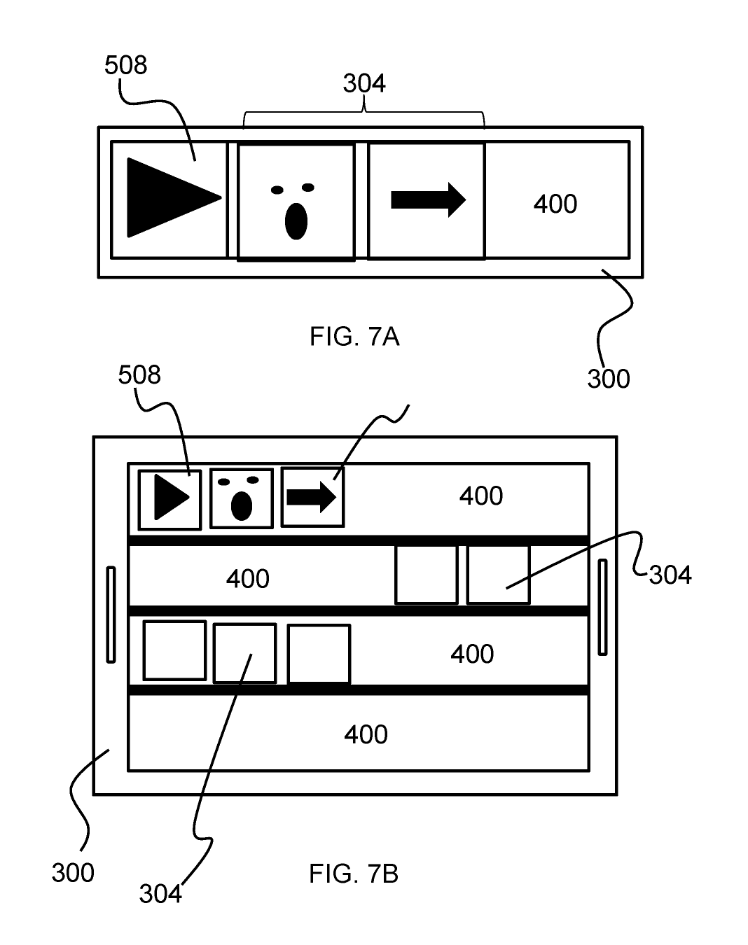

FIGS. 7A and 7B illustrate a single row tray 300 and a multi-row tray, respectively. The beginner set includes the beginner tray 300 with a control block 508 on the tray 300. It also comes with a few command blocks 304. The control block 508 includes Bluetooth technology or an RFID reader. Some embodiments of the tray 300 have additional technology in the bottom of the tray 300 that helps detect which side of the command blocks 304 is facing upwards as well as where the block 304 is positioned within the tray 300 (e.g., 1^{st}, 2^{nd}, 3^{rd}, 4^{th} position).

Therefore, the tray 300 can assess different things in regards to the command blocks 304, including what blocks 304 are in the tray 300, where each block 304 is within the tray 300 in relation to one another, and which side is facing upwards on each block 304. Although specific examples are provided above, it should be noted that the tray 300 can read any element of the blocks 304 and/or all of them at the same time and all permutations in between. As another non-limiting example, there is another specific element to be assessed. Depending on which side a block 304 is facing, the tray 300 might read the face of the block 304 four ways. Consider an arrow on the top side of the block 304 that could be facing up/down/left/right.

As described above, the command blocks 304 can have RFID emitters or be enabled with Bluetooth. These blocks 304 can have multiple (e.g., six) RFID chips in them, such that each RFID chip refers to a distinct side of a six-sided block 304. The blocks 304 can also have bumps on each side in specific locations, so that the combination of the block 304 and the RFID chip would coordinate to inform the tray 300 or the control block 508 which blocks 304 are within the tray 300. Typically, the RFID chip on the bottom of the block 304, the one closest or directly connected to the tray 300, is the RFID chip being read. The command corresponds to the face of the block on the opposite side, facing upwards. The other five RFID chips in the block 304 are turned off either through the use of a metal casing or shield that makes the RFID chip unreadable by the tray 300 when it's open side is not facing the tray 300. Alternatively, the block 304 may include another sensor that senses it should disable all of the other emitters to eliminate any confusion of which RFID chip should be read. Although the term “metal” may be used, it should be noted that the invention is not intended to be limited thereto and includes any material or design implementation that shields the RFID from going through.

The beginner tray 300 then emits the information above via Bluetooth, a RFID writer, cable, etc., to either an electronic device, such as a mobile phone, mobile tablet, laptop, smart television, or any kind of device with the relevant software app (e.g., Mia & Codie app) being used. The beginner tray 300 may also transmit this information to any product designed to read the information and then ‘act out’ the command. This can include toy robots, cars, trucks, planes, robotic animals, or any other object designed to work in the system.

For beginner trays 300 with multiple rows (FIG. 7B), one embodiment of the tray 300 requires blocks 304 to be read from left to right, and then top to bottom. Another embodiment of the tray 300 requires blocks 304 to be read starting from the top, and snaking around the tray 300 (which can also be referred to as a board). For example, the tray 300 or board can be read like rows of words in a book (starting in top left corner, reading across, then moving back to the left side of the next row). Another example would be to snake around.

As described above, additional tracks 302 can be connected directly to the beginner tray 300 via the male/female connectors (elements 502 and 506) on the ends, or any other suitable connection technique or device, including magnets, Velcro, etc. These tracks 302 work the same way as the beginner tray 300 does. The track 302 has the same ability to read the information from the block 304, and pass this along to the control block 508 on the beginner tray 300.

In addition, control blocks 508 with the added technology in them (matching the control block 508 on the beginner tray 300) can come separately from the beginner tray 300. A user can place this control block 508 on any tray 300, and the control block 508 can then read all the other blocks 305 on the tray 300, and any connected trays 300, the same way the control block 508 on the beginner tray 300 can read them. Each command block 304 may also have a RFID emitter that can tell the block 304 to its left or right what command it is pointing to, as well as all the commands on its other side. As an example, if there is a five block tray 300, with a control block 508 on the far left, and four command blocks 304 positioned to the right of the control block 508 on the tray 300, then block five (element 304) might emit a command to block four (element 304). Block four (element 304) reads the command from block five (element 304), and then emits the command from block five (element 304) and block four (element 304) to block three (element 304). Block three (element 304) reads the string of commands from blocks four and five (element 304), and passes on a new string including the commands from blocks 3, 4, 5 to block 2 (element 304). Block 2 (element 304) now passes on the information from Block 2, 3, 4, 5 (element 304) to the command block 304, which now can emit the commands to the mobile or TV device, or to the object toy.

In another embodiment of the system, blocks 304 operate without any tray. In this format, the system works much the same as above where all the technology is in the control block 508, and command blocks 508 are passing that information back to the control block 508 by simply being laid in a line. Another variation of the blocks 304 is they have small connectors on them so that the blocks 304 will only work when they are touching each other (i.e., when the string has been connected). On one end, must be the control block 508, which could be a play button (as illustrated in FIGS. 5, 7A, 7B, and FIG. 8), an object block (depicting an object), or a character block (depicting a cartoon character or a written character (e.g., alphanumerical character).

(2.2) Game Play Example

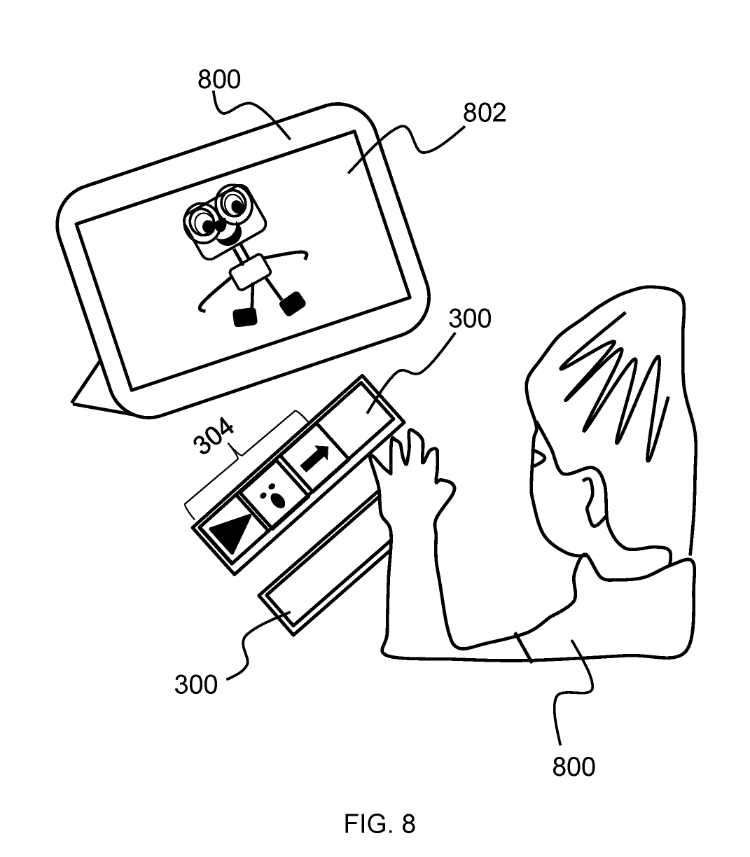

FIG. 8 is an illustration of a child 800 using the blocks 304 and trays 300 according to embodiments of the present disclosure. Blocks 304 represent an object that can easily translate from a tactile real world off-screen to a visual 2D world onscreen, such as on a tablet 800, mobile phone, or other electronic device having a display screen 802.

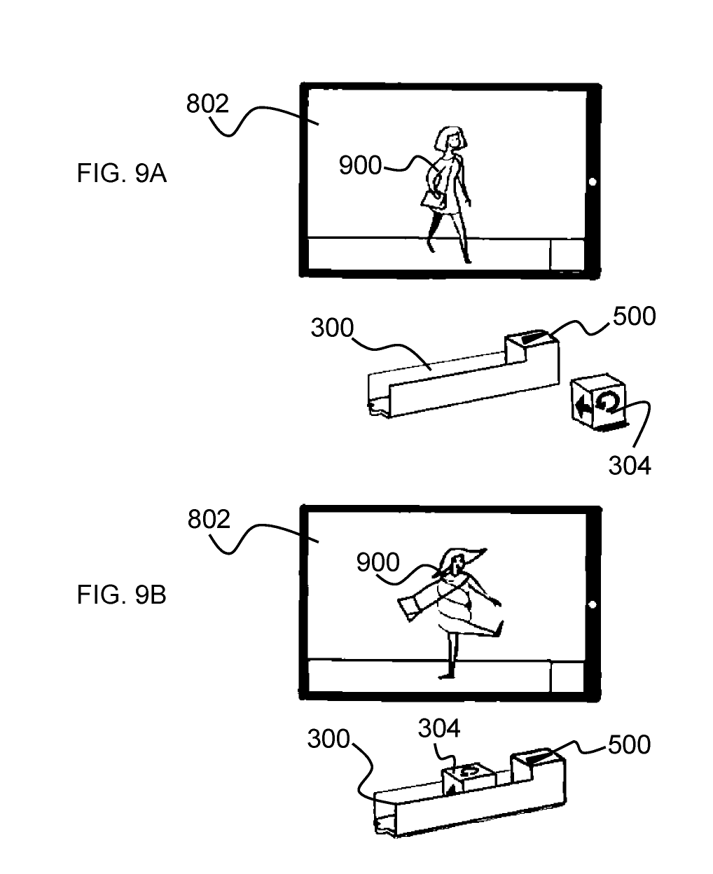

FIG. 9A shows display screen 802 displaying a female character 900 walking forward. The tray 300 is open at the beginning and ends with the play button (i.e., command element 500). In FIG. 9B, a command block 304, in this case “spin”, is placed in the tray 300, causing the female character 900 to spin, as displayed on the display screen 802.

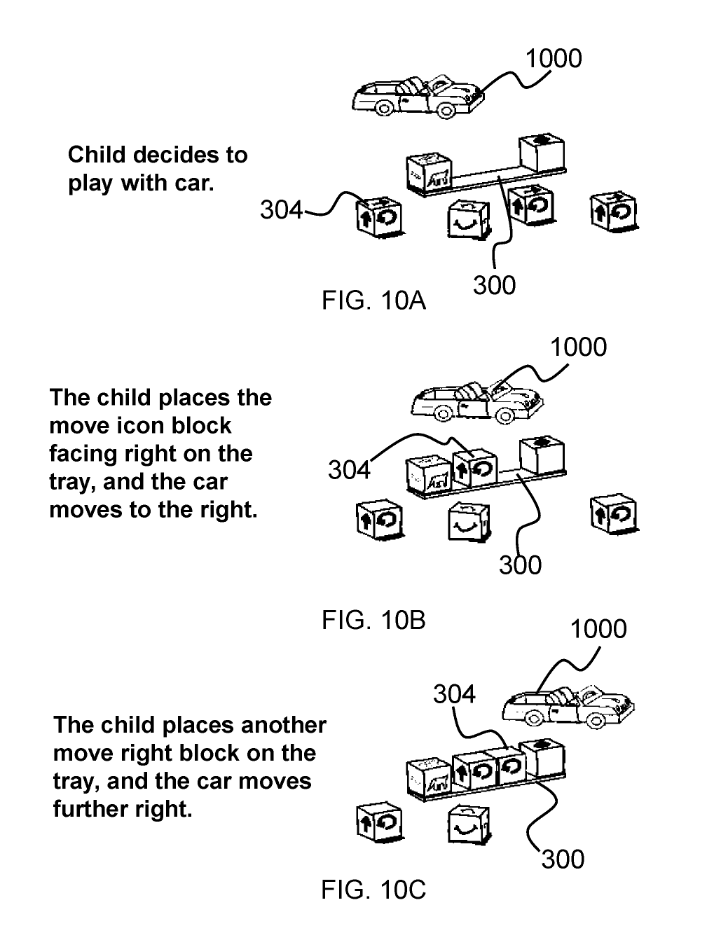

FIGS. 10A-10C depict a play scenario for controlling a toy car 1000. In FIG. 10A, a child decides to play with the toy car 1000. In FIG. 10B, the child places the move icon block 304 facing right on the tray 300, and the toy car 1000 moves right. In FIG. 10C, the child places another move right block 304 on the tray 300, and the toy car 1000 moves further right. Bluetooth technology can be used to emit the command to the toy robot or toy car, and, based on the command, the toy robot or toy car would perform an action or mechanism (e.g., motor that causes wheels to move or turn) that causes the toy to move (e.g., drive, walk, jump, dance).

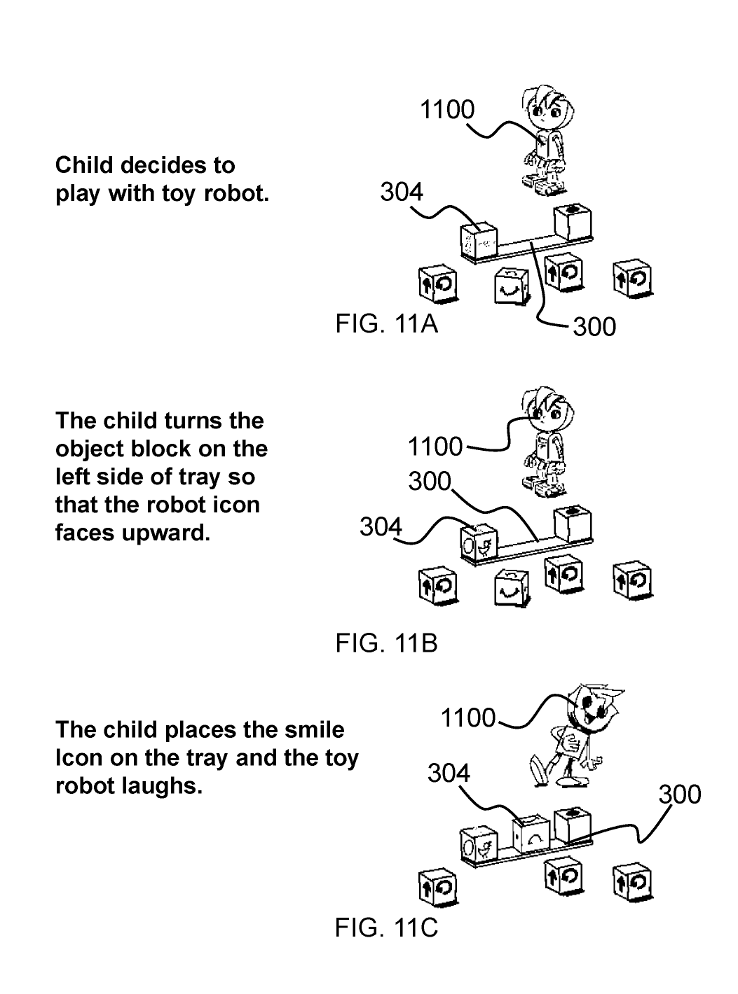

FIGS. 11A-11C depict a play scenario for controlling a toy robot 1100. In FIG. 11A, a child decides to play with the toy robot 1100. In FIG. 11B, the child turns the object block 304 on the left side of the tray 300 so that the robot icon on the object block 304 faces upward. In FIG. 11C, the child places the smile icon block 304 on the tray 300, and the toy robot 1100 laughs.

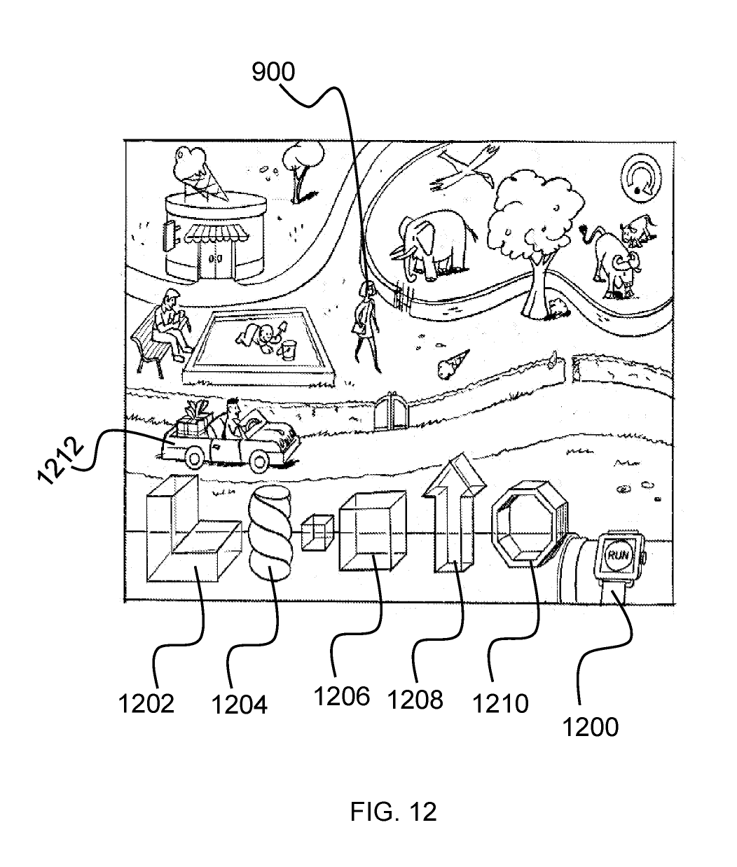

FIG. 12 is an illustration of an example interface according to embodiments of the present disclosure. In this interface image, the tray at the bottom represents a character's arm or the player's arm which would correspond to the tray/platform 300 described herein. The watch 1200 is projecting the blocks as holograms, which represent sit/bend 1202, shrink 1204, grow 1206, send upward 1208, and stop 1210. Since some objects in the landscape are moving, such as the car 1212, when the car 1212 reaches a send upward 1208 block based on user placement of the corresponding block in the tray 300, the car 1212 will start moving upward and off screen.

Alternatively, an algorithm or sequence of commands can be created. For instance, the player can select an object block for placement in the tray 300, such as the female character 900. If the player presses the run button, all of the blocks lined up in the tray 300 will fly toward the woman and be applied to her as they hit her. She would sit down, then spin, then shrink, then grow again, then fly up, then stop. The watch would read the name of the commands as they are applied. For instance, “Sit! Spin! Shrink! Grow! Send up! Stop. End.”

Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

It will be readily apparent to persons skilled in the relevant arts that various modifications and improvements may be made to the foregoing embodiments, in addition to those already described, without departing from the basic inventive concepts of the present invention.

What is claimed is:

1. A system for controlling an object via a plurality of multi-sided manipulable objects, comprising:
a plurality of manipulable objects having distinct sides, wherein each manipulable object comprises at least one radio frequency identification (RFID) chip;
a recipient object; and
a platform for receiving at least one manipulable object, wherein the platform comprises a RFID reader which can detect, using the at least one RFID chip in each manipulable object, at least one of a position, an orientation, and an order of one or more manipulable objects placed on the platform,
wherein the platform is configured for emitting a command to the recipient object corresponding to at least one of the position, the orientation, and the order of the one or more manipulable objects placed on the platform.

2. The system as set forth in claim 1, wherein each manipulable object is a block, and wherein each distinct side of the block comprises an image conveying a command related to an object, animal, person, action, alphanumeric character, symbol, or emotion.

3. The system as set forth in claim 2, wherein the recipient object is a toy object capable of movement, and wherein the platform is configured for wirelessly transmitting a command or sequence of commands to the toy object corresponding to an image on a block or a sequence of images on a sequence of blocks positioned on the platform to induce movement of the toy object.

4. The system as set forth in claim 3, wherein the toy object is a toy car.

5. The system as set forth in claim 3, wherein the toy object is a toy robot.

6. The system as set forth in claim 2, wherein the recipient object is an electronic device having a display screen, and wherein the platform is configured for wirelessly transmitting a command or sequence of commands to software on the electronic device capable of rendering graphics on the display screen corresponding to an image on a block or a sequence of images on a sequence of blocks positioned on the platform.

7. The system as set forth in claim 1, further comprising an additional platform having a connection mechanism for connecting with one or more other platforms.

8. The system as set forth in claim 1, wherein the platform comprises a plurality of rows for receiving the plurality of manipulable objects.

9. A method for controlling an object via a plurality of multi-sided manipulable objects, comprising acts of:
forming a plurality of manipulable objects having distinct sides, wherein each manipulable object is formed to have at least one radio frequency identification (RFID) chip;
forming a platform for receiving at least one manipulable object, wherein the platform is formed having a RFID reader which can detect, using the at least on RFID chip in each manipulable object, at least one of a position, an orientation, and an order of one or more manipulable objects placed on the platform; and
forming a recipient object for receiving commands from the platform.

10. The method as set forth in claim 9, further comprising acts of:
positioning at least one manipulable object on the platform;
emitting, by the platform, a command to the recipient object corresponding to at least one of the position, the orientation, and the order of the one or more manipulable objects placed on the platform; and
causing the recipient object to perform an action corresponding to the at least one of the position, the orientation, and the order of the one or more manipulable objects placed on the platform.

11. The method as set forth in claim 9, wherein each manipulable object is formed as a block, and wherein each distinct side of the block is formed to have an image conveying a command related to an object, animal, person, action, alphanumeric character, symbol, or emotion.

12. The method as set forth in claim 10, wherein the recipient object is a toy object capable of movement, and wherein the method further comprises acts of:
wirelessly transmitting, by the platform, a command or sequence of commands to the toy object corresponding to an image on a block or a sequence of images on a sequence of blocks positioned on the platform; and
inducing movement of the toy object based on the command or sequence of commands.

13. The method as set forth in claim 10, wherein the toy object is formed as a toy car.

14. The method as set forth in claim 10, wherein the toy object is formed as a toy robot.

15. The method as set forth in claim 10, wherein the recipient object is an electronic device having a display screen, and wherein the method further comprises acts of:
wirelessly transmitting, by the platform, a command or sequence of commands to software on the electronic device capable of rendering graphics on the display screen; and
causing graphics corresponding to an image on a block or a sequence of images on a sequence of blocks positioned on the platform to be displayed on the display screen.

16. The method as set forth in claim 9, further comprising an act of forming an additional platform having a connection mechanism for connecting with one or more other platforms.

17. The method as set forth in claim 9, further comprising an act of forming the platform to have a plurality of rows for receiving the plurality of manipulable objects.
